(19) United States
(12) Patent Application Publication
(10) Pub. No.: US 2004/0006819 A1
(43) Pub. Date: Jan. 15, 2004

(54) Arrangement in a bed for a disabled person, and a bed provided with the aid arrangement

(76) Inventor: Bengt Johansson, Kyrkesund (SE)

Correspondence Address: YOUNG & THOMPSON, 745 SOUTH 23RD STREET 2ND FLOOR, ARLINGTON, VA, 22202

(21) Appl. No.: 10/362,529

(22) PCT Filed: Aug. 24, 2001
(86) PCT No.: PCT/SE01/01807

(30) Foreign Application Priority Data
Aug. 25, 2000 (SE) 0003008-0

(51) Int. Cl. A61G 7/053

(52) U.S. Cl. 5/81.1 R; 5/84.1; 5/83.1

(57) ABSTRACT

An arrangement in a bed (1) intended for a disabled person and comprising a horizontally rotatable multi-sectional bed base part (3a, 3b) supporting a mattress, the base part being convertible into a seat part (3b) and a backrest part (3a), together with a fixed bed base part (3c). The arrangement furthermore comprises a lifting mechanism 82a) connected to the rotatable bed base parts (3a, 3b) supporting the mattress, the mechanism 82a) being operatively connected to a safety hook (A), that can be connected to a lifting sling, for example, which is worn by the person.

The present invention relates to an arrangement in a bed intended for a disabled person, and more specifically an arrangement by means of which the said person can be lowered down onto and raised up from a bed, and a bed provided with the said arrangement.

For obvious reasons, a disabled (paralysed or senile) person has difficulty getting in and out of bed. Helping such a person out of bed and into bed is therefore a daily task for relatives or nursing staff. Such lifting carries with it considerable risk of injury because the posture of the person(s) assisting is in most cases extremely unfavourable in terms of the load stresses sustained.

There are great benefits in enabling disabled people to continue to live and work in a familiar home environment. Being able to manage for as long as possible without personal assistance from others is likewise desirable not only for reasons of cost, but also from the purely personal standpoint of those affected. Various technical aids are often essential in enabling people with restricted mobility to carry on living and coping at home whilst maintaining an acceptable quality of life.

U.S. Pat. No. 5,444,883 shows a bed with rotatable mattress part which makes it easier for a disabled person to get in and out of bed. This known bed assumes, however, that the person has sufficient mobility and strength in their arms to be able get up, unassisted, from a sitting position on the bed and down into a wheel chair, or into a standing position.

The main object of the present invention is to provide an arrangement in a bed, which can be used as an aid when rising from a bed or getting into a bed and which solves the aforementioned problems of heavy lifting, and which provides the facility to enable even a seriously disabled person to get into bed and up from the bed by themselves.

According to the invention this object is achieved in that the arrangement has the characteristics specified in the claims.

Another advantage of the invention is that the process of getting into and out of a bed can be tailored to each individual, modified movement patterns being readily achievable not only through motorised control of a rotatable part of the bed base with associated mattress part, but also through motorised control of an integrated lifting mechanism. A further advantage of the invention is that even very heavy persons can be safely lifted into and out of bed from a wheel chair, for example, without the risk of the bed overturning.

The invention will now be described with reference to exemplary embodiments shown in the drawing attached, in which

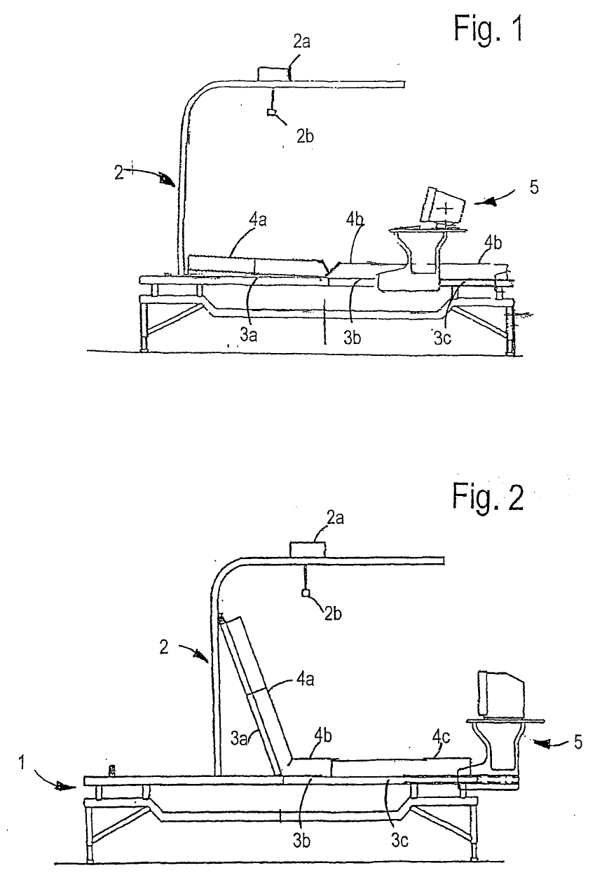

FIG. 1 shows a simplified, diagrammatic side view of an arrangement in a bed according to the invention in a lowered position,

FIG. 2 shows a diagrammatic side view corresponding to FIG. 1 of an arrangement and bed part in a position with the patient sitting upright,

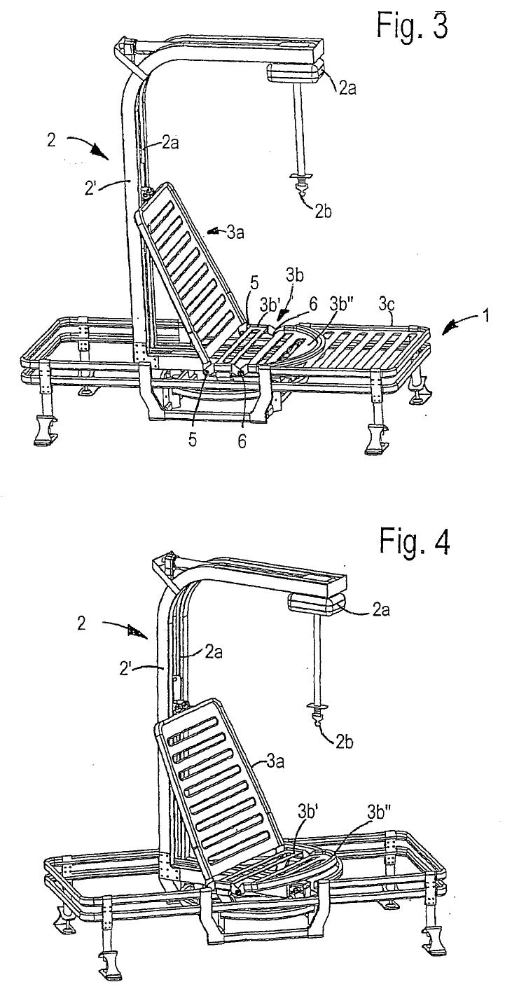

FIG. 3 shows a perspective view corresponding to that in FIG. 2, but without mattress and showing various parts of the rotatable, multi-sectional bed base part supporting the mattress before commencing rotation of the bed base part,

FIG. 4 shows the rotatable, multi-sectional bed base part supporting the mattress after a 45-degree turn, and in which the front section of this base part has been shown angled upright in order to retain the patient safely,

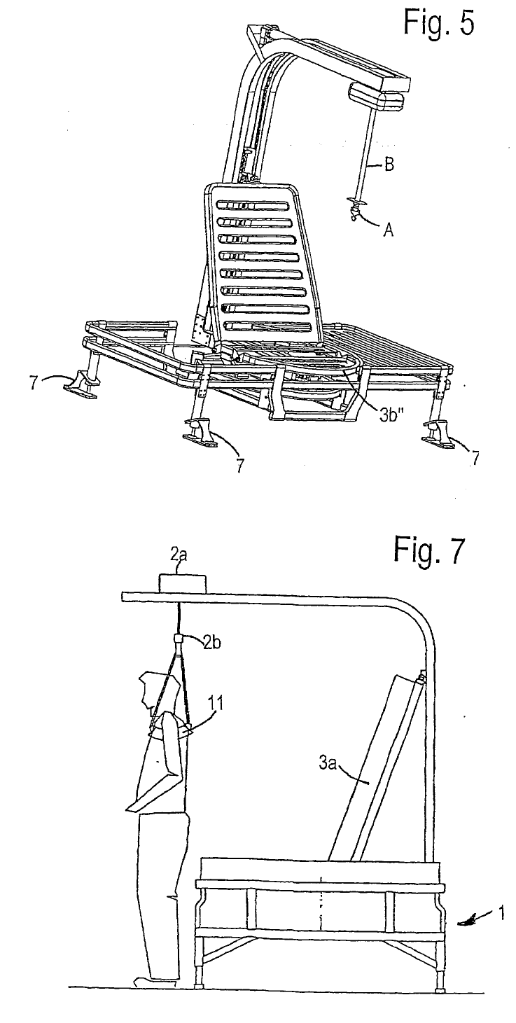

FIG. 5 shows the rotatable, multi-sectional bed base part supporting the mattress after a 90-degree rotation into a position allowing a person to get in and out of bed,

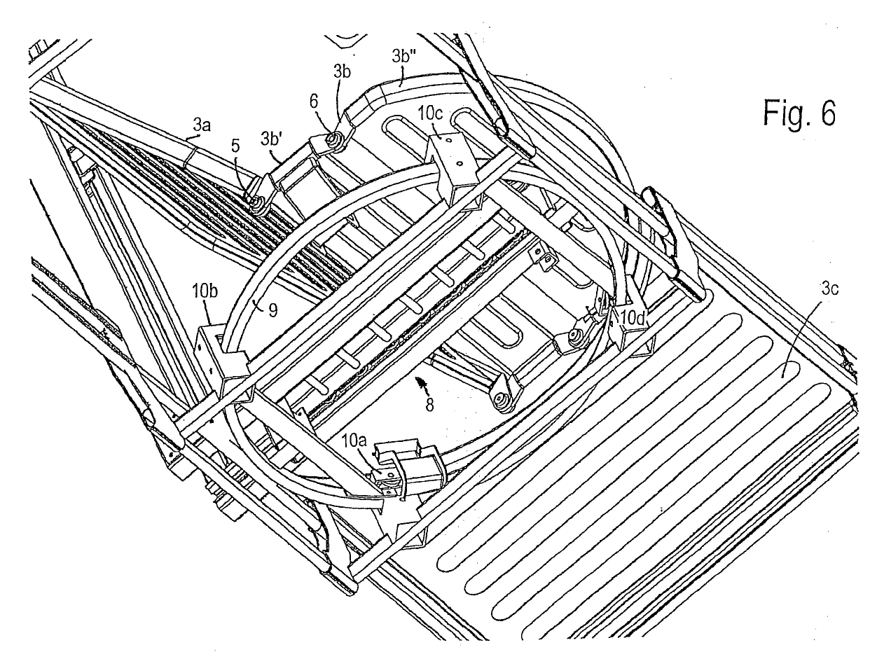

FIG. 6 shows a view of an arrangement according to the invention from beneath, and how the rotatable, multi-sectional bed base part supporting the mattress is operatively connected to a telescopically collapsible pedestal arrangement, and in which

FIG. 7 shows a diagrammatic view from the end of the arrangement with the bed having a person secured in a lifting sling for getting into and out of the bed.

FIG. 1 shows a simplified, diagrammatic side view of an arrangement 2 in a bed 1 according to the invention with the backrest part/head end 3a, 4a in a in a lowered position. The arrangement 2 has a lifting mechanism 2a and a lifting hook 2b for the connection of a lifting sling—see further description in connection with FIG. 7. A specially designed and divided mattress 4a-c is also shown in FIG. 1. The lower mattress part 4c is immovable on the bed base part 3c, and is connected by a curved edge part (not visible in the figure) to the mattress part 4b, supported by the rotatable, multi-sectional bed base part 3a. The mattress part 4a is suitably fixed to the bed base part 3a by Velcro tape, or the like. The reference number 5 relates to a bedside table, which is moveably arranged by the bed 1 and can be pushed aside and, if necessary, lowered when making the bed whilst simultaneously lifting the patient.

FIG. 2 shows a side view of the bed 1 according to FIG. 1, with backrest part/head end 3a/4a in a raised position, permitting an upright sitting position in the bed 1.

FIG. 3 shows a view of an arrangement 2 and bed 1 corresponding to that in FIG. 2, but here in a perspective view and without mattress and showing various parts 3a, 3b and 3c of the rotatable, multi-sectional bed base part supporting the mattress before commencing a rotation of the bed base part 3a, 3b. Here therefore, the bed base part is shown divided into two parts moveable in relation to one another, the bottom, fixed part 3c, together with middle part 3b and top part 3a, The pedestal 2′ has an open slot 2a, the top section of the bed base part 3a being guided so that can slide in the said slot. The mattress parts 4a-4c therefore have shapes that correspond to the shapes of the bed base parts 3a-3c, which is an essential prerequisite if the mattress parts 4a and 4b and the bed base parts 3a and 3b are to be movable, turnable or rotatable in relation to the mattress 4c and bed base part 3c. It will also be seen from FIG. 3 that the bed base part 3b is articulated, partly at the bed base part 3a, at 5, but also at 6 in such a way that the bed base part 3b will comprise two parts 3b′ and 3b″ rotatable in relation to one another.

FIG. 4 shows in more detail why the bed base part 3b is divided up. The front part 3b″ is, in fact, designed to be capable of swinging upwards in order to create a support for the patient's thighs, partly in order to provide a greater sense of security when the bed base part 3a, 3b is rotated with the patient seated, but also in order to raise the patient's lower legs, so as to minimise their pressure against the mattress part 4c, with the object of permitting a lateral swivelling of the lower legs and feet when the bed base part is rotated through 90 degrees into the position for getting out of bed.

FIG. 5 shows the rotatable, multi-sectional bed base part 3a, 3b supporting the mattress after a 90-degree rotation into a position allowing a person to get in and out of bed. Here the front bed base part 3b″ is shown in a horizontal, reclined position, making lifting/getting out of bed and down into a wheel chair, for example, easier. It is obviously advantageous if the time that the patient spends suspended in a lifting sling can be minimised, a short lifting time being preferable not only due to risk of circulatory problems, but also purely from the point of view of comfort. FIG. 5 also shows arrangements 7 in the bottom part of the foot of the bed 1, designed to prevent overturning. These support arrangements 7 increase the moment arm counteracting the overturning of the bed 1. The said supports 7 can easily be turned in under the bed should their use not be necessary.

FIG. 6 shows a view of the rotatable bed base parts 3a and 3b from beneath, and of a telescopic mechanism 8, which is here shown in its fully telescoped position. The telescopic mechanism 8 assumes its fully extended position when the bed is in the position shown in FIG. 1, that is to say in the bed's sleeping position. In principle, one linear adjusting device suffices both for adjusting the bed base part 3a into an upright position and for adjusting the telescopic mechanism 8 into a telescoped position, since the top part of the bed base part 3a slides and is guided in the slot 2a in the pedestal 3c. FIG. 6 also shows how the bed base part 3a, 3b and telescopic part are arranged in the bed frame. A support and bearing ring 9 is fixed in the bed frame. The bed base part 3a, 3b and the telescopic part 8 are supported on the said ring by way of a bearing housing 10a-10d, which has supported rollers, which run against the upper side of the support and bearing ring. An outer gear tooth profile is suitably connected to one side of the support and bearing ring 9, in which gear tooth profile one or more gear wheels engage for rotation of the bed base part 3. In a preferred embodiment a toothed belt (not shown) is fixed to opposing outer sides of the bearing ring 9 and has a length such that the belt can pass over two tensioning wheels and a motor-driven toothed belt pinion wheel fixed to the bed frame in order to bring about rotation of the bearing ring and the bed base parts 3a, 3b. Limit switches on the bearing ring 9 limit the possible rotation.

FIG. 7 finally shows a diagrammatic view from the end of the arrangement with the bed having a person secured in a lifting sling 11 for getting into and out of the bed.

The invention is not confined to the exemplary embodiment shown above but lends itself to modifications within the scope of the claims set out below.

1. Arrangement in a bed (1) intended for a disabled person and comprising a horizontally rotatable multi-sectional bed base part (3a, 3b) supporting a mattress, the base part being convertible into a seat part (3b) and a backrest part (3a), together with a fixed bed base part (3c), characterised in that the arrangement furthermore comprises a lifting mechanism (2a) connected to the said rotatable bed base parts (3a, 3b) supporting the mattress, the mechanism (2a) being operatively connected to a safety hook (A), that can be connected to a lifting sling, for example, which is worn by the said person.

2. Arrangement according to claim 1, characterised in that the operative connection consist of a belt or a line (B).

3. Arrangement according to claim 1, characterised by a vertical pedestal (2′) against which the backrest part (3a) of the said bed base slidably bears.

4. Arrangement according to claim 3, characterised in that the vertical pedestal (2′) has, at the top, a horizontal beam part (2″) accommodating a motor-driven winch mechanism (2a), arranged so that it can traversed along the said beam part (2″).

5. Arrangement according to claim 3, characterised in that the vertical pedestal (2′) is horizontally displaceable by means of a telescopic mechanism (8), which is rotatable together with the multi-sectional bed base part (3a, 3b).

6. Arrangement according to any of the preceding claims 1, characterised by auxiliary motors for turning the bed base part (3a, 3b) and for converting the said bed base part into a backrest part (3a) and a seat part (3b), the working of the said auxiliary motors being controlled by way of a program control with regard to their movement pattern for getting into and out of the said bed depending upon the turning position of the bed base part (3) in the horizontal plane.

7. Arrangement according to claim 6, characterised in that it is directly maneuverable by the user by means of a maneuvering control unit.

8. Bed (1) for a disabled person, comprising an arrangement according to any of the preceding claims, characterised in that at least one laterally directed, moment-absorbing support (7) serving to prevent overturning, is arranged in connection with any leg of the bed
